(19) United States
(12) Patent Application Publication
(10) Pub. No.: US 2015/0286827 A1
(43) Pub. Date: Oct. 8, 2015

(54) METHOD AND APPARATUS FOR NEARLY OPTIMAL PRIVATE CONVOLUTION

(71) Applicants: Nadia FAWAZ, Santa Clara, CA (US); Aleksandar Todorov NIKOLOV, New York, NY (US); THOMSON LICENSING, Issy-les-Moulineaux (FR)

(72) Inventors: Nadia Fawaz, Santa Clara, CA (US); Aleksandar Todorov Nikolov, New York, NY (US)

(21) Appl. No.: 14/648,881

(22) PCT Filed: Nov. 27, 2013
(86) PCT No.: PCT/US2013/072165

§ 371 Date: Jun. 1, 2015

Related U.S. Application Data
(60) Provisional application No. 61/732,606, filed on Dec. 3, 2012.

(51) Int. Cl. G06F 21/60; G06F 17/14; G06F 21/62; G06F 17/15

(52) U.S. Cl. CPC G06F 21/60; G06F 17/153; G06F 17/14; G06F 21/6245

(57) ABSTRACT

A method and apparatus for ensuring a level of privacy for answering a convolution query on data stored in a database is provided. The method and apparatus includes the activities of determining (402) the level of privacy associated with at least a portion of the data stored in the database and receiving (404) query data, from a querier, for use in performing a convolution over the data stored in the database. The database is searched (406) for data related to the received query data and the data that corresponds to the received query data is retrieved (408) from the database. An amount of noise based on the determined privacy level is generated (410) and added (412) to the retrieved data to create noisy data which is then communicated (414) to the querier.

### CROSS-REFERENCE TO RELATED APPLICATIONS

This application claims priority from a U.S. Provisional Patent Application Ser. No. 61/732,606 filed on Dec. 3, 2012, which is fully incorporated by reference herein.

### BACKGROUND OF THE INVENTION

The general problem of computing private convolutions has not been considered in the literature before. However, some related problems and special cases have been considered. Bolot et al. give algorithms for various decayed sum queries: window sums, exponentially and polynomially decayed sums. Any decayed sum function is a type of linear filter, and, therefore, a special case of convolution.

Additionally, the work of Barak et al. on computing k-wise marginals concerns a restricted class of convolutions. Moreover, Kasiviswanathan show a noise lower bound for k-wise marginals which is tight in the worst case. A defect associated with these methods is the reduced class of queries to which the generalizations described therein apply.

In the setting of (ε, 0)-differential privacy, Hardt and Talwar prove nearly optimal upper and lower bounds on approximating Ax for any matrix A. Recently, their results were improved, and made unconditional by Bhaskara et al. However, a drawback associated with this work is that a similar result is not known for the weaker notion of approximate privacy, i.e. (ε, δ)-differential privacy. In particular determining the gap between the two notions of privacy is an interesting open problem, both in terms of noise complexity and computational efficiency.

Therefore, a need exists to obtain nearly optimal results for a private convolution to find an instance optimal (ε, δ)-differentially private algorithm for general matrices. A further needs exists to derive a differentially private algorithm that is less computationally expensive. A system according to invention principles remedies the drawbacks associated with these and other prior art systems.

### SUMMARY OF THE INVENTION

The present invention gives a nearly optimal (ε, δ)-differentially private approximation for a convolution operation, which includes any decayed sum function as a particular case. However, unlike Bolot et al. (discussed above), the present invention considers the offline batch-processing setting, as opposed to the online continual observation setting. Additionally, the present invention remedies defects associated with Barak and Kasiciswanathan by providing generalization which provides nearly optimal approximations to a wider class of queries. Another advantage of the present invention is that the lower and upper bounds used nearly match for any convolution. Moreover, the present invention provides nearly optimal results for private convolution as a first step in the direction of finding an instance optimal (ε, δ)-differentially private algorithm for general matrices A. The present algorithm is advantageous because it is less computationally expensive. Prior art algorithms are computationally expensive, as they need to sample from a high-dimensional convex body. By contrast the present algorithm's running time is dominated by the running time of the Fast Fourier Transform. Furthermore, the present invention advantageously uses previously developed but unapplied tools for generation of the lower bound which relates to the noise necessary for achieving (ε, δ)-differential privacy to combinatorial discrepancy.

In one embodiment, a method for ensuring a level of privacy for data stored in a database is provided. The method includes the activities of determining the level of privacy associated with at least a portion of the data stored in the database and receiving query data, from a querier, for use in performing a computation (e.g performing a search or aggregating elements of data) on the data stored in the database. The database is searched for data related to the received query data and the data that corresponds to the received query data is retrieved from the database. An amount of noise based on the determined privacy level is generated. Thereafter, the retrieved data undergoes some processing and some distortion (for example noise might be added at some step of the processing), to create a distorted (or noisy) answer to the query which is then communicated to the querier.

In another embodiment, a method for computing a private convolution is provided. The method includes receiving private data, x, the private data x being stored in a database and receiving public data, h, the public data h being received from a querier. A controller transforms the private and public data to obtain transformed private data \hat{x} and transformed public data Ĥ. A privacy processor adds noise to the transformed private data \hat{x} to obtain a noisy transformed private data \tilde{x} and multiplies the noisy transformed private data with the transformed public data to obtain a product data y̅=Ĥ\tilde{x}. The privacy processor inverse transforms the product data y̅ to obtain the privacy preserving output \tilde{y} and releases \tilde{y} to the querier.

In a further embodiment, an apparatus for computing a private convolution is provided. The apparatus includes means for storing private data, x and means for receiving public data, it, from a querier. The apparatus also includes means for transforming the private and public data to obtain transformed private data \hat{x} and transformed public data Ĥ and means for adding noise to the transformed private data \hat{x} to obtain a noisy transformed private data \tilde{x}. A means for multiplying the noisy transformed private data with the transformed public data to obtain a product data y̅=Ĥ\tilde{x} is provided along with a means for inverse transforming the product data to obtain privacy preserving output \tilde{y} for release to the querier.

In another embodiment, an apparatus for computing a private convolution is provided. The apparatus includes a database having private data, x, stored therein and a controller that receives public data, h, from a querier and transforms the private and public data to obtain transformed private data \hat{x} and transformed public data Ĥ. A privacy processor adds noise to the transformed private data \hat{x} to obtain a noisy transformed private data \tilde{x}, multiplies the noisy transformed private data with the transformed public data to obtain a product data y̅=Ĥ\tilde{x}, and inverse transforms the product data to obtain privacy preserving output \tilde{y} for release to the querier.

### BRIEF DESCRIPTION OF THE DRAWING FIGURES

FIG. 1 is a block diagram of an embodiment of the system according to invention principles;

FIG. 2 is a block diagram of another embodiment of the system according to invention principles;

FIG. 3 is a line diagram detailing an exemplary operation of the system according to invention principles;

FIG. 4A is a flow diagram detailing the operation of an algorithm implemented by the system according to invention principles;

FIG. 4B is a flow diagram detailing the operation of an algorithm implemented by the system according to invention principles.

### DETAILED DESCRIPTION

It should be understood that the elements shown in the Figures may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

If used herein, the term “component” is intended to refer to hardware, or a combination of hardware and software in execution. For example, a component can be, but is not limited to being, a process running on a processor, a processor, an object, an executable, and/or a microchip and the like. By way of illustration, both an application running on a processor and the processor can be a component. One or more components can reside within a process and a component can be localized on one system and/or distributed between two or more systems. Functions of the various components shown in the figures can be provided through the use of dedicated hardware as well as hardware capable of executing software in association with appropriate software.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein. The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

The application discloses a novel way to compute the convolution of a private input x with a public input h on a database, while satisfying the guarantees of (ε, δ)-differential privacy. Convolution is a fundamental operation, intimately related to Fourier Transforms, and useful for multiplication, string products, signal analysis and many algebraic problems. In the setting disclosed herein, the private input may represent a time series of sensitive events or a histogram of a database of confidential personal information. Convolution then captures important primitives including linear filtering, which is an essential tool in time series analysis, and aggregation queries on projections of the data.

More specifically, a nearly optimal algorithm for computing convolutions on a database while satisfying (ε, δ)-differential privacy is disclosed herein. In fact, the algorithm is instance optimal: for any fixed h, any other (ε, δ)-differentially private algorithm will have at most a polylogarithmic factor (in the size of x) less mean expected square errors than the proposed algorithm in this invention. It has been discovered that the optimality is achieved by following the simple strategy of adding independent Laplacian noise to each Fourier coefficient and bounding the privacy loss using the conventional composition theorem known from C. Dwork, G. N. Rothblum, and S. Vadhan. “Boosting and Differential Privacy” in Foundations of Computer Science (FOCS), 2010 51st Annual IEEE Symposium on, pages 51-60. IEEE, 2010. The application discloses a closed form expression for the optimal noise to add to each Fourier coefficient using convex programming duality. The algorithm disclosed herein is efficient—it is essentially no more computationally expensive than a Fast Fourier Transform. To prove optimality, the recent discrepancy lowerbounds described in S. Muthukrishnan and Aleksandar Nikolov. “Optimal Private Halfspace Counting via Discrepancy.” Proceedings of the 44th ACM Symposium on Theory of Computing, 2012 is used and a spectral lower bound is derived using a characterization of discrepancy in terms of determinants.

The noise complexity of linear queries is of fundamental interest in the theory of differential privacy. Consider a database that represents users (or events) of N different types. We may encode the database as a vector x\vec{} indexed by {1, . . . , N}. A linear query asks for an approximation of a dot product <a, x> and a workload of M queries may be represented as a matrix A. The desired result from the linear query is the intended output representing an approximation to Ax. As the database may encode information that is desired to remain private (e.g. personal information, etc.), we advantageously approximate queries in a way that does not compromise the individuals represented in the data. That is to say, the present system advantageously ensures the privacy of each individual associated with the data being sought by the query. To accomplish this privacy objective, the system according to the invention principles utilizes a differential privacy algorithm that provides (ε, δ)-differential privacy. An algorithm is differentially private if its output distribution does not change drastically when a single user/event changes in the database. Thus, the system advantageously adds a predetermined amount of noise to any result generated in response to the query. This advantageously ensures the privacy of the individuals in the database with respect to the party that supplied the query, according to the (ε, δ)-differential privacy notion.

The queries in a workload A can have different degrees of correlation, and this poses different challenges for the algorithm. In one extreme, when A is a set of Ω(N) independently sampled random {0,1} (i.e. counting) queries, we know that any (ε, δ)-differentially private algorithm should incur Ω(N) squared error per query on average. On the other hand, if A consists of the same counting query repeated M times, we only need to add O(1) noise per query. Those two extremes are well understood the upper and lower bounds cited above are tight. Thus, the numerical distance between the upper and lower bounds is relatively small.

Convolution is a mathematical operation on two different sequences to produce a third sequence which may be a modified version of one of the original two sequences processed. The convolution of the private input x with a public vector h is defined as the vector y where

$${y}_{k} = {\sum }_{n = 0}^{N - 1} {h}_{n} {x}_{( k - n ) ( mod N )} ,$$

for k in {0, . . . , N−1}. Equivalently, the convolution can also be written

$${y}_{k} = {\sum }_{j = 0}^{N - 1} {x}_{n} {h}_{( k - n ) ( mod N )} ,$$

for k in {0, . . . , N−1}. Computing convolution of x presents us with a workload of N linear queries. Each query is a circular shift of the previous one, and, therefore, the queries are far from independent but not identical either.

Convolution is a fundamental operation that arises in algebraic computations from polynomial multiplication to string products such as counting mismatches, and others. It is also a basic operation in signal analysis and has well known connection to Fourier transforms. Convolutions have applicability in various applications including, but not limited to linear filters and in aggregating queries made to a database. In the field of linear filters, the analysis of time series data can be cast as convolution. Thus, linear filtering can be used to isolate cycle components in time series data from spurious variations, and to compute time-decayed statistics of the data. When used in aggregating queries, convolutions are used when user type in the database is specified by d binary attributes, aggregate queries such as k-wise marginals and generalizations can be represented as convolutions.

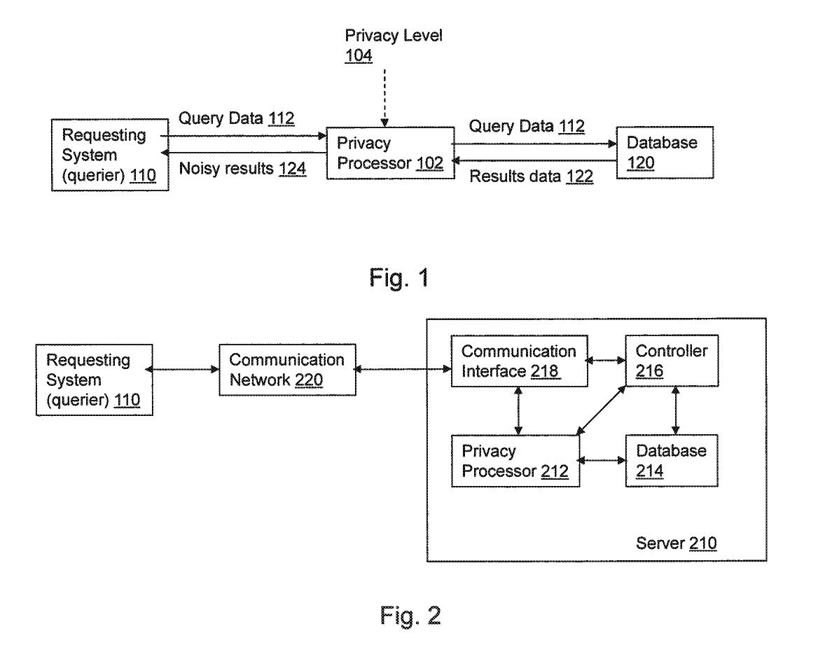

Privacy concerns arise naturally in these applications. For example, certain time series data can contain records of sensitive events including, but not limited to, financial transactions, medical data or unemployment figures. Moreover, some of the attributes in a database can be sensitive. Such is the case when the database is populated with patient medical data. Thus in studying differential privacy of linear queries, the set corresponding to convolutions is a particularly important case, from foundational and application points of view. A system that ensures differential privacy of data stored in a data storage medium is shown in FIG. 1. The system advantageously receives query data from a requesting system that is used to perform a particular type of computation (e.g. a convolution) on data stored in a database. A requesting system may also be referred to as querier. The querier is any individual, entity or system (computerize or other) that generates a query data usable to execute a convolution on data stored in a database that is to be kept private. The system processes the query data to return data representative of the parameters set forth in the query data. In processing the query data, the return data may be processed and during the processing of the return data, the system intelligently adds a predetermined amount of noise data to the processed query result data thereby balancing the need to provide a query result that contains useful data while maintaining a differential privacy level of the data from the database. It should be understood that the system may perform other processing functions on the data returned in response to the query data. The processing may include going to the frequency domain by Fourier transform, and adding noise in that domain to some of the entries of the user data \hat{x} in the frequency domain, then multiplying by Ĥ, and then inverting the Fourier transform to go back to the time domain, and obtain the noisy \tilde{y}. Thus, hereinafter, the discussion of adding noise to the results data may include the situation when the noise is being added directly to the raw results data as well as a situation where the data undergoes some other type of processing prior to the addition of the noise data. The predetermined amount of noise is used to selectively distort the data retrieved in response to the query when being provided back to the querier. The selective distortion of the query result data ensures privacy by satisfying the differential privacy criterion. Thus, the system implements a predetermined privacy algorithm that will generate a near optimal amount of noise data to be added to the results data based on the query. If too much noise is added, the results will be overly distorted thereby reducing the usefulness of the result and if an insufficient amount of noise is added then the result could compromise the privacy of the individuals and/or attributes with which the data is associated.

A block diagram of a system 100 that ensures differential privacy of data stored in a storage medium 120 is shown in FIG. 1. The system 100 includes a privacy processor 102. The privacy processor 102 may implement the differential privacy algorithm for assigning a near optimal amount of noise data to ensure that a desired privacy level associated with the data is maintained. The system further includes a requesting system 110 that generates query data used in querying the data stored in the storage medium 120. As shown herein, the storage medium 120 is a database including a plurality of data records and associated attributes. Additionally, the storage medium 120 may be indexed thereby enabling searching and retrieval of data therefrom. The storage medium 120 being a database is described for purposes of example only and any type of structure that can store an indexed set of data and associated attributes may be used. However, for purposes of ease of understanding, the storage medium 120 will be generally referred to as a database.

A requesting system 110 generates data representing a query used to request information stored in the database 120. It should be understood that the requesting system 110 may also be an entity that generates the query data and is referred to throughout this description as a “querier”. Information stored in the database 120 may be considered private data x whereas query data may be considered public data h. The convolution query generated by the querier may be noted as h when the convolution query is in the time domain or ĥ when the convolution query is in the frequency domain. The requesting system 110 may be any computing device including but not limited to a personal computer, server, mobile computing device, smartphone and a tablet. These are described for purposes of example only and any device that is able to generate data representing a query for requesting data may be readily substituted. The requesting system 110 may generate the query data 112 in response to input by a querier of functions to generate a convolution (e.g. convolution query data) that may be used by the database to retrieve data therefrom. In one embodiment, the query data 112 represents a linear query. In another embodiment, the query data 112 may be generated automatically using a set of query generation rules which govern the operation of the requesting system 110. For example, the query data 112 may also be generated at a predetermined time interval (e.g. daily, weekly, monthly, etc). In another embodiment, the query data may be generated in response to a particular event indicating that query data is to be generated and thereby triggers the requesting system 110 to generate the query data 112.

The query data 112 generated by the requesting system 110 is communicated to the privacy processor 102. The privacy processor 102 may parse the query data 112 to identify the database being queried and further communicate and/or route the query data 112 to the desired database 120. The database 120 receives the query data 112, and a computation is initiated on data stored therein using the convolution query data 112 and retrieves data deemed to be relevant to the convolution query. In doing such, the private data x is transformed into transformed private data \hat{x} whereas the public data h is transformed into private public data ĥ.

The database 120 generates results data 122 including at least one data record that is related to the query data and communicates the results data 122 to the privacy processor 102. The results data including at least one data record is described for purposes of example only and it is well known that the result of any particular query may return no data if no matches to the query data 112 are found. However, for ease of understanding the inventive concepts including ensuring the differential privacy of the data stored in the database, the result data 122 will be understood to include at least one data record.

Upon receipt of the results data 122 from the database 120, the privacy processor 102 executes the differential privacy algorithm to transform the results data into noisy results data 124 which is communicated back to the requesting system 110. The differential privacy algorithm implemented by the privacy processor 102 receives data representing a desired privacy level 104 and uses the received privacy level data to selectively determine an amount of noise data to be added to the results data 122. The differential privacy algorithm uses the privacy level data 104 to generate a predetermined type of noise. In one embodiment, the type of noise added is Laplacian Noise. The privacy processor 102 adds noise to the transformed private data \hat{x} to obtain noisy transformed private data \tilde{x}. The noisy transformed data \tilde{x} is multiplied with the transformed public data Ĥ to obtain product data (e.g. results data) y̅=Ĥ x̅. The product data y̅ is inverse transformed to obtain privacy preserved output data \tilde{y} which can then be released (e.g. communicated via a communication network) to the querier.

The differential privacy algorithm implemented by the privacy processor 102 may be an algorithm for computing convolution under (ε, δ)-differential privacy constraints. The algorithm provides the lowest mean squared error achievable by adding independent (but non-uniform) Laplacian noise to the Fourier coefficients \hat{x} of x and bounding the privacy loss by the composition theorem of Dwork et al. For any fixed h, up to polylogarithmic factors, any (ε, δ) differential private algorithm incurs at best a polylogarithmic factor less mean squared error per query than the algorithm used by the present system thus showing that the simple strategy above is nearly optimal for computing convolutions. This is the first known nearly instance-optimal (ε, δ)-differentially private algorithm for a natural class of linear queries. The privacy algorithm is simpler and more efficient than related algorithms for (ε, δ)-differential privacy.

Upon adding the predetermined amount of noise to results data 122, the privacy processor 102 transforms results data 122 into noisy result data 124 and communicates the noisy result data 124 back to the requesting system 110. The noisy results data 124 may include data indicating the level of noise added thereby providing the requesting system 110 (or a user/querier thereof) with an indication as to the distortion of the retrieved data. By notifying the requesting system 110 (or user/querier thereof) of the level of distortion, the requesting system 110 (and user) is provided with an indication as to the reliability of the data.

The privacy algorithm implemented by the privacy processor 102 relies on a privacy level data 104 which represents a desired level of privacy to be maintained. As discussed above, the privacy level data 104 is used to determine the upper and lower bounds of the privacy algorithm and the amount of noise added to the data to ensure that level of privacy is maintained. Privacy level data 104 may be set in a number of different ways. In one embodiment, the owner of the database 120 may determine the level of privacy for the data stored therein and provide the privacy level data 104 to the privacy processor 102. In another embodiment, the privacy level data 104 may be based on a set of privacy rule stored in the privacy processor 102. In this embodiment, the privacy rules may adaptively determine the privacy level based on at least one of (a) a characteristic associated with the data stored in the database; (b) a type of data stored in the database; (c) a characteristic associated with the requesting system (and/or user); and (d) a combination of any of (a)-(c). Privacy rules can include any information that can be used by the privacy processor 102 in determining the amount of noise to be added to results data derived from the database 120. In a further embodiment, the privacy data 104 may be determined based on credentials of the requesting system. In this embodiment, the privacy processor 102 may parse the query data 112 to identify information about the requesting system 110 and determine the privacy level 104 based on the information about the system. For example, the information about the requesting system 110 may provide subscription information that determines how distorted the data provided to that system should be and determines the privacy data 104 accordingly. These embodiments for determining the privacy level are described for purposes of example only and any mechanism for determining the distortion level associated with data retrieved based on query data may be used.

Additionally, although not specifically shown, persons skilled in the art will understand that all communication between any of the requesting system 110, privacy processor 102, and database 120 may occur via a communication network, either local area or wide area (e.g. the internet).

The inclusion of a single requesting system 110 and single database 120 is described for purposes of example only and to facilitate the understanding of the principles of the present invention. Persons skilled in the art will understand that the privacy processor 102 may receive a plurality of different requests including query data from at least one of the same requesting system and/or other requesting systems. Moreover, the privacy processor 102 may also be in communication with one or more databases 120 each having their own respective privacy level data 104 associated therewith. Thus, the privacy processor 102 may function as an intermediary routing processor that selectively receives requests of query data and routes those requests to the correct database for processing. In this arrangement, the privacy processor 102 may also receive request data from respective databases 120 depending on the particular query data. Therefore, the privacy processor 102 may be able to selectively determine the correct amount of noise for each set of received data based on its respective privacy level 104 and communicate those noisy results back to the appropriate requesting system 110.

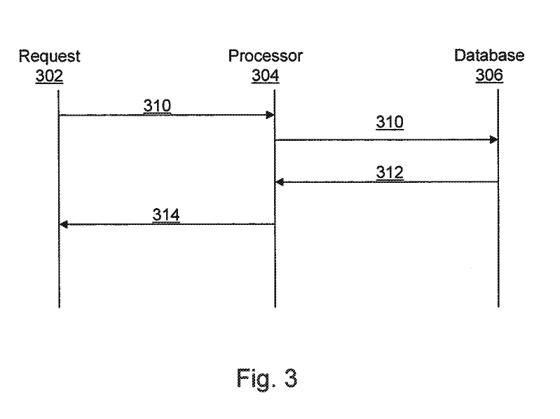

FIG. 2 is an alternative embodiment of the system 100 for ensuring differential privacy of data stored in a database. In this embodiment, a requesting system 110, similar to the one described in FIG. 1, is selectively connected to a server 210 via a communication network 220. The communication network 220 may be any type of communication network including but not limited to a local area network, a wide area network, a cellular network, and the internet. Additionally, the communication network 220 may be structured to include both wired and wireless networking elements as is well known in the art.

The system depicted in FIG. 2 shows a server 210 housing a database 214 and a privacy processor 212. The database 214 and privacy processor 212 are similar in structure, function and operation to the database 120 and privacy processor 102 described above in FIG. 1. The server 210 also includes a controller 216 that executes instructions for operating the server 210. For example, the controller 216 may execute instructions for structuring and indexing the database 214 as well as algorithms for searching and retrieving data from the database 214. Additionally, the controller 218 may provide the privacy processor 212 with privacy level data that is used by the privacy processor 212 in determining the amount of noise to be added to any data generated in response to a search query generated by the requesting system 110. The server 210 also includes a communication interface 218 that selectively receives query data generated by the requesting system and communicated via communication network 220. The communication interface 218 also selectively receives noisy results data generated by the privacy processor 212 for communication back to the requesting system via the communication network 220.

An exemplary operation of the embodiment shown in FIG. 2 is as follows. The requesting system 110 generates a request including query data for searching a set of data stored in database 214 of the server 210. In one embodiment, the query data is a convolution query. The request is communicated via the communication network 220 and received by the communication interface 218. The communication interface 218 provides the received data to the controller 216 which parses the data to determine the type of data that was received. In response to determining that the data received by the communication interface is query data, the controller 218 generates privacy level data and provides the privacy level data to the privacy processor 212. The controller 218 also processes the query data to query the database 214 using the functions in the query data. Data stored in the database 214 that corresponds to the query data is provided to the privacy processor 212 which executes the differential privacy algorithm to determine an amount of noise to be added to the results of the query. In another embodiment, prior to providing the data based on the query to the privacy processor 212, the controller 216 may implement other further processing of the data as needed. Upon completion of any further processing by the controller 216, the processed data may then be provided to the privacy processor 212. The privacy processor 212 transforms the results data (or the processed results data) into noisy data that reflects the desired privacy level and provides the noisy data to the communication interface 218. The noisy data may then be returned to the requesting system 110 via the communication interface.

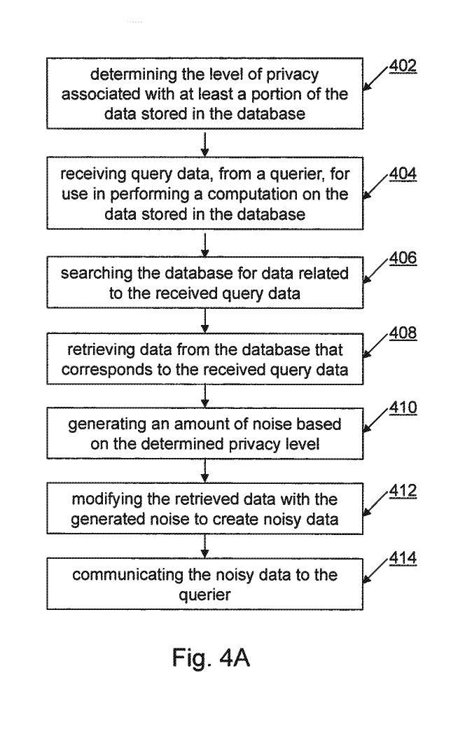

FIG. 3 is a timeline diagram describing the process of requesting data from a database, modifying the data to ensure differential privacy thereof and returning the modified data to the requesting party. As shown herein, there are three entities that one of generate and act upon data. They include a requesting system/querier 302, a privacy processor 304 and a database 306. The requesting system/querier 302 generates a request 310 including query data, the query data being a convolution query. The generated request 310 is received by the privacy processor 304 which provides the request 310 to the database 306 for processing. The database 306 uses the elements of the convolution in the query data contained in the request 310 and processes the convolution with respect to the database 306 to generate results data. The results data 312 is communicated back to the privacy processor 304. In another embodiment, prior to providing the results data to the privacy processor 304, the results data may have other processing performed thereon. The privacy processor 304 uses a predetermined privacy level that may be at least one of (a) associated with the querier; (b) provided by the owner of the database 306; and (c) dependent on a characteristic associated with the type of data stored in the database 306. The privacy processor 304 executes the differential privacy algorithm to determine the upper and lower bounds thereof based on the determined privacy level to determine and apply a near optimal amount of noise to the results data 312 to generate noisy data 314. The noisy data 314 is then communicated back to the requesting user/querier 302 for use thereof. In one embodiment, the noisy data 314 includes an indicator identifying how distorted the data is from its pure form represented by the results data 312 to be used as needed.

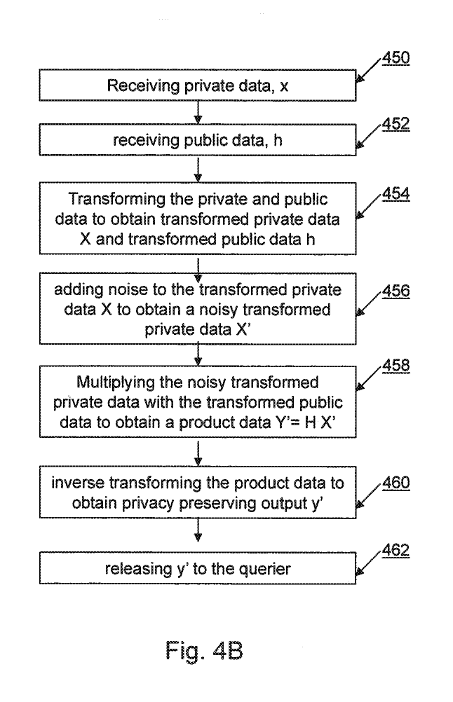

A flow diagram detailing an operation of the privacy algorithm and system for implementing such is shown in FIG. 4A. The flow diagram details a method for obtaining data from a database such that the retrieved data satisfies (ε, δ)-differential privacy constraints. In step 402, the level of privacy associated with at least a portion of the data stored in the database is determined. In another embodiment, determining a privacy level includes at least one of (a) receiving data representing the privacy level from an owner of the database; (b) generating data representing the privacy level using a characteristic associated with the user whose data is stored in the database; and (c) generating data representing the privacy level using a characteristic associated with the data stored in the database. In step 404, query data is received from a querier for use in searching the data stored in the database. In one embodiment, the data stored in the database includes private content in a time domain. In another embodiment, the data stored in the database is transformed into a frequency domain by using Fourier transformation. In step 406, the database is searched for data related to the received query data. In step 408, data from the database that corresponds to the received query data is retrieved. In step 410, an amount of noise based on the determined privacy level is generated and in step 412, the generated noise is added to the retrieved data to create noisy data. In step 414, the noisy data is communicated to the querier. In one embodiment, the amount of noises is an amount of independent Laplacian noise which is determined by convex programming duality and is added to the data to satisfy the determined privacy level. In another embodiment, the amount of independent Laplacian noise is added to data in the frequency domain for satisfying the determined privacy level. In a further embodiment, the noisy data is transformed back into time domain by inverse Fourier transform and then communicated to the querier.

FIG. 4B is another algorithm for obtaining privacy preserving data that satisfies (ε, δ)-differential privacy constraints. In understanding this algorithm the variables described therein should be understood to mean the following:
x: original private data in the time domain
\hat{x}: original private data in the frequency domain
h: original public data in the time domain
Ĥ: original public data in the frequency domain
y: original answer to the query in the time domain
ŷ: original answer to the query in the frequency domain
\tilde{x}: noisy private data in the frequency domain
y̅: noisy answer to the query in frequency domain
\tilde{y}: noisy answer to the query in the time domain
   In step 450, private data, x is received, the private data x being stored in database (120 in FIG. 1 or 214 in FIG. 2). In step 452, public data h is received from a querier (requesting user or system). In one embodiment, the public data is received by the privacy processor 102 in FIG. 1. In another embodiment, as shown in FIG. 2, the public data is received by a communication interface 218 via communication network 220 and provided to the controller 216. In step 454, the private and public data are transformed to obtain transformed private data \hat{x} and transformed public data Ĥ, respectively. In one embodiment, the transformation of step 454 is performed by the privacy processor 102 in FIG. 1. In another embodiment, the transformation in step 454 may be performed by the controller 216 in FIG. 2. In step 456, a privacy processor (102 in FIG. 1 or 212 in FIG. 2) adds noise to the transformed private data \hat{x} to obtain a noisy transformed private data \tilde{x}. The noisy transformed private data is multiplied, by the privacy processor, with the transformed public data to obtain a product data y̅=Ĥ\tilde{x} in step 458. In step 460, the privacy processor inverse transforms the product data to obtain privacy preserving output \tilde{y} which may be released (e.g. communicated back to the querier/requesting user/request system) in step 462.

The following discussion includes the basis of the differential privacy algorithm executed by the privacy processor 102 in FIGS. 1 and 212 in FIG. 2 and outlined in the flow diagram of FIG. 4.

The recent discrepancy-based noise lower bounds of Muthukrishnan and Nikolov shows that the differential privacy algorithm executed by the privacy processor is nearly optimal. This quasi-optimality is evidence for the robustness of the discrepancy lower bounds. Previous techniques for lower bounds against (ε, δ)-differential privacy, such as using the smallest eigenvalue of the query matrix A, did not capture the inherent difficulty of approximating some sets of linear queries. For example, repeating a query does not change the approximability significantly, but makes the smallest eigenvalue zero. The present differential privacy algorithm uses a characterization of discrepancy in terms of determinants of submatrices discovered by Lovász, Spencer, and Vesztergombi, together with ideas by Hardt and Talwar, who give instance-optimal algorithms for the stronger notion of (ε, 0)-differential privacy because establishing instance-optimality for (ε, δ)-differential privacy, as in the present system, is harder from error lower bounds perspective, as the privacy definition is weaker. A main technical ingredient in our proof is a connection between the discrepancy of a matrix A and the discrepancy of PA where P is an orthogonal projection operator.

The differential privacy algorithm executed by the privacy processor advantageously solves problems associated with computing private convolutions. The differential privacy algorithm provides nearly optimal (ε, δ)-differentially private approximation for any decayed sum function. Moreover, the present differential privacy algorithm advantageously provides optimal approximations to a wider class of queries, and the values of the lower and upper bounds used in the algorithm nearly match for any given convolution. Thus, the present differential privacy algorithm may provide optimal results for private convolution that may be used as a first step in finding an instance optimal (ε, δ)-differentially private algorithm for general matrices A. Moreover, the present algorithm is less computationally expensive because prior privacy algorithms require samples from a high-dimensional convex body. By contrast the present differential privacy algorithm is dominated by the running time of the Fast Fourier Transform.

The following description of the differential privacy algorithm, its basis and proof of near optimality utilizes the following notation. [symbol] , [symbol] , and [symbol] are the sets of non-negative integers, real, and complex numbers, respectively. By log we denote the logarithm in base 2 while by ln we denote the logarithm in base e. Matrices and vectors are represented by boldface upper and lower cases, respectively. A^{T}, A*, A^{H} stand for the transpose, the conjugate and the transpose conjugate of A, respectively. The trace and the determinant of A are respectively denoted by tr(A) and det(A). Aₘ, denotes the m-th row of matrix A, and A_{:n} its n-th column. A|_{S}, where A is a matrix with N columns and S⊂[N], denotes the submatrix of A consisting of those columns corresponding to elements of S. λ_{A}(1), . . . , λ_{A}(n) represent the eigenvalues of an n×n matrix A. I_{N} is the identity matrix of size N. E[•] is the statistical expectation operator and Lap (x, s) denotes the Laplace distribution centered at x with scale s, i.e. the distribution of the random variable x+η where η has probability density function p(y)∝exp(−|y|/s).

In order to understand the advantages provided by the differential privacy algorithm according to invention principles, it is important to understand the concept of circular convolutions and the important results on the Fourier eigen-decomposition of convolution.

Convolution

To begin Let x={x₀, . . . , x_{N-1}} be a real input sequence of length N, and h={h₀, . . . , h_{N-1}} a sequence of length N. The circular convolution of x and h is the sequence y=x*h of length N defined by

yₖ=Σₙ₌₀^{N-1}xₙh_{(k-n)mod N}, ∀kε{0, . . . ,N−1} (1)

Definition 1: provides that the N×N circular convolution matrix H is defined as

$$H = {[ \begin{matrix}{h}_{0} & {h}_{N - 1} & {h}_{N - 2} & … & {h}_{1} \\ {h}_{1} & {h}_{0} & ⋱ & ⋱ & ⋮ \\ {h}_{2} & ⋱ & ⋱ & ⋱ & {h}_{N - 2} \\ ⋮ & ⋱ & ⋱ & {h}_{0} & {h}_{N - 1} \\ {h}_{N - 1} & … & {h}_{2} & {h}_{1} & {h}_{0}\end{matrix} ]}_{N \times N}$$

This matrix is a circulant matrix with first column h=[h₀, . . . hₙ₋₁]^{T}ε [symbol] ^{N}, and its subsequent columns are successive cyclic shifts of its first column. Note that H is a normal matrix (HH^{H}=H^{H}H). Additionally, we define the column vectors x=[x₀, . . . xₙ₋₁]^{T}ε [symbol] ^{N} and y=[y₀, . . . yₙ₋₁]^{T}ε [symbol] ^{N}. Thus, the circular convolution described in Equation (1) can be written in matrix notation y=Hx. Below it is shown that the circular convolution can be diagonalized in the Fourier basis.

Fourier Eigen-Decomposition of Convolution

The definition of the Fourier basis and the eigen-decomposition of circular convolution in this basis is as follows. From Definition 2, the normalized Discrete Fourier Transform (DFT) matrix of size N is defined in Equation (2) as

$${F}_{N} = {\{ \frac{1}{\sqrt{N}} exp ( - \frac{j 2 π mn}{N} ) \}}_{m , n ∈ \{ 0 , … , N - 1 \}} \qquad ( 2 )$$

We note that, based on Equation (2), the matrix F_{N} is symmetric (F_{N}=F_{N}^{T}) and unitary (F_{N}F_{N}^{H}=F_{N}^{H}F_{N}=I_{N}). We can then denote

$${f}_{m} = {[ 1 , {e}^{\frac{j 2 π m}{N}} , … , {e}^{\frac{j 2 π m ( N - 1 )}{N}} ]}^{T} ∈ {ℂ}^{N}$$

the m-th column of the inverse DFT matrix F_{N}^{H}. Alternatively, ƒₘ^{H} is the m-th row of F_{N} and the normalized DFT of a vector h is simply given by ĥ=F_{N}h.

Moreover, according to Theorm 1 derived from Gray, in Toeplitz and circulant matrices: a review. Foundations and Trends in Communications and Information Theory, 2(3):155-239, 2006, any circulant matrix H can be diagonalized in the Fourier basis F_{N} and the eigen-vectors of H are given by the columns {ƒₘ}_{mε{0, . . . , N-1}} of the inverse DFT matrix F_{N}^{H}, and the associated eigenvalues {λₘ}_{mε{0, . . . , N-1}} are given by \sqrt{N}ĥ, i.e. by the DFT of the first column h of H as follows:

$${∀}_{m} ∈ \{ 0 , … , N - 1 \} , \\ {Hf}_{m} = {λ}_{m} {f}_{m}$$

$$where$$

$${λ}_{m} = \sqrt{N} {\hat{h}}_{m} = {\sum }_{n = 0}^{N - 1} {h}_{n} {e}^{- \frac{j 2 π mn}{N}}$$

Equivalently, in the Fourier domain, the circular convolution matrix H becomes a diagonal matrix Ĥ=diag {\sqrt{N}ĥ}.

From the above, we arrive at Corollary 1 which considers the circular convolution y=Hx of x and h. Further, let \hat{x}=F_{N}x and ĥ=F_{N}h denote the normalized DFT of x and h. Thus, in the Fourier domain, the circular convolution becomes a simple entry-wise multiplication of the components of \sqrt{N}ĥ with the components of \hat{x}:ŷ=F_{N}y=Ĥ\hat{x}.

We now consider the Privacy Model used in the algorithm according to invention principles. With respect to the Privacy Model, we first consider the Differential Privacy, the Laplace Noise Mechanism and the Composition Theorems which represents the consequences of the definition of differential privacy.

Differential Privacy

Initially consider that, two real-valued input vectors x,x′ε[0,1]^{N} are neighbors when ∥x−x′∥₁≦1 and Definition 3 states that a randomized algorithm [symbol] satisfies (ε, δ)-differential privacy if for all neighbors x,x′ε[0,1]ⁿ, and all measurable subsets T of the support of [symbol] , in the following holds

Pr[ [symbol] (x)εT]≦e^{ε}Pr[ [symbol] (x′)εT]+δ

where probabilities are taken over the randomness of [symbol] .

Laplace Noise Mechanism

Considering now the mechanism of generating the Laplacian Noise, we look to Definition 4 which states that a function ƒ:[0,1]^{N}→ [symbol] has sensitivity s if s is the smallest number such that for any two neighbors x,x′ε[0,1]^{N},

|ƒ(x)−ƒ(x′)|≦s.

From there, Theorem 2 put forth by Dwork et al. in Calibrating noise to sensitivity in private data analysis. In TCC, 2006, states that if we let ƒ:[0,1]^{N}→ [symbol] have sensitivity s and suppose that on input x, the algorithm [symbol] outputs ƒ(x)+z, where z˜Lap(0, s/ε). Then (ε, 0)-differential privacy is satisfied.

Composition Theorems

An important feature of differential privacy is its robustness. When an algorithm is a “composition” of several differentially private algorithms, the algorithm itself also satisfies differential privacy constraints, with the privacy parameters degrading smoothly. The results in this subsection quantify how the privacy parameters degrade.

The first composition theorem, Theorem 3, which can be derived from Dwork et al., is an easy consequence of the definition of differential privacy. Theorem 3 states that, if we let [symbol] ₁ satisfy (ε₁, δ₁)-differential privacy and [symbol] ₂ satisfy (ε₂, δ₂)-differential privacy, where [symbol] ₂ could take the output of [symbol] ₁ as input, then the algorithm which on input x outputs the tuple ( [symbol] ₁(x), [symbol] ₂( [symbol] ₁(x),x)) satisfies (ε₁+ε₂, δ₁+δ₂)-differential privacy.

Dwork et al. also proved a more sophisticated composition theorem (Theorem 4), which often gives asymptotically better bounds on the privacy parameters. Theorem 4 states that if we let [symbol] ₁, . . . [symbol] ₖ be such that algorithm [symbol] ᵢ satisfies (εᵢ, 0)-differential privacy, then the algorithm that, on input x outputs the tuple (A₁(x), . . . , A₁(x)) satisfies (ε, δ) differential privacy for any δ>0 and

$$ɛ \geq \sqrt{2 ln ( \frac{1}{δ} ) {\sum }_{i}^{m} {ɛ}_{i}^{2}} .$$

However, while the above definitions and theorems are useful in differential privacy determinations, they do not satisfy differential privacy constraints in a convolution problem as in the present invention. In the convolution problem, we are given a public sequence h={h₁, . . . , h_{N}} and a private sequence x={x₁, . . . x_{N}}. Thus, the present privacy algorithm is (ε,δ)-differentially private with respect to the private input x (taken as column vector x), and approximates the convolution h*x. More precisely, we look to Definition 5 which states that, given a vector hε [symbol] ^{N} which defines a convolution matrix H, the mean (expected) squared error (MSE) of an algorithm [symbol] , which measure the mean expected square errors per output component, is defined as

$$MSE = {sup}_{x ∈ {ℝ}^{N}} \frac{1}{N} E [ {‖ ( x ) - Hx ‖}_{2}^{2} ]$$

In order to minimize the MSE per output, both the upper and lower bounds of the privacy algorithm need be determined. In determining these bounds, the present algorithm advantageously minimizes the distance between the upper and lower bounds thereby minimizing the MSE per output. Below is described the lower bound determination followed by a discussion of the upper bound determination.

Lower Bounds

In this section we derive spectral lower bounds on the MSE of differentially private approximation algorithms for circular convolution. We prove that these bounds are nearly tight for every fixed it in the following section. The lower bounds are based on recent work by S. Muthukrishnan and Aleksandar Nikolov. (Optimal private halfspace counting via discrepancy. Proceedings of the 44th ACM symposium on Theory of computing, 2012) which connects combinatorial discrepancy and privacy. By adapting a strategy set out by Hardt and Talwar, the present algorithm instantiates the basic discrepancy lower bound for any matrix PA, where P is a projection matrix, and use the maximum of these lower bounds. However, we need to resolve several issues that arise in the setting of (ε,δ)-differential privacy. While projection works naturally with the volume-based lower bounds of Hardt and Talwar, the connection between the discrepancy of A and PA is not immediate, since discrepancy is a combinatorially defined quantity. The present algorithm advantageously advances the current technical understanding by analyzing the discrepancy of PA via the determinant lower bound of Lovāsz, Spencer, Vesztergombi.

To begin, we first define (l₂) hereditary discrepancy as

$$herdisc ( A ) = {max}_{W ⊆ [ N ]} {min}_{v ∈ {\{ - 1 , + 1 \}}^{w}} {‖ A v ‖}_{2}$$

The following result connects discrepancy and differential privacy.

In Theorem 5, A is an M×N complex matrix and [symbol] be an (ε,δ)-differentially private algorithm for sufficiently small constant ε and δ. Additionally, there exists a constant C and a vector xε{0,1}^{N} such that

$$E [ {‖ ( x ) - A x ‖}_{2}^{2} ] \geq C \frac{{herdisc ( A )}^{2}}{{log}^{2} N} .$$

From this, the determinant lower bound for hereditary discrepancy based on the models described by Lovász, Spencer, and Vesztergombi gives us a spectral lower bound on the noise required for privacy.

Additionally in Theorem 6, there exists a constant C′ such that for any complex M×N matrix A herdisc (A)≦C′ max_{K,\vec{B}}\sqrt{K}|det (B)|^{1/K}, where K ranges over 1, . . . , min{M,N} and B ranges over K×K submatrices of A.

Based on theorems 5 and 6, we arrive at Corollary 7 and Corollary 8. Corollary 7 states that if A is an M×N complex matrix and let [symbol] be an (ε,δ)-differentially private algorithm for sufficiently small constant ε and δ, there exists a constant C and a vector xε{0,1}^{N} such that, for any K×K submatrix B of A,

$$E [ {‖ A ( x ) - A x ‖}_{2}^{2} ] \geq C \frac{K {\vert det ( B ) \vert}^{2 / K}}{{log}^{2} N} .$$

Corollary 8 formally states that the observation that projections do not increase the error of an algorithm (with respect to the projected matrix). In Corollary 8, we let A be an M×N complex matrix and let [symbol] be an (ε,δ)-differentially private algorithm for sufficiently small constant ε and δ. Thus, there exists a constant C and a vector xε{0,1}^{N} such that for any L×M projection matrix P and for any K×K submatrix B of PA,

$$E [ {‖ ( x ) - A x ‖}_{2}^{2} ] \geq C \frac{K {\vert det ( B ) \vert}^{2 / K}}{{log}^{2} N} .$$

Indeed, we can prove that there exists an (ε,δ)-differentially private algorithm [symbol] that satisfies Equation 3

E[∥ [symbol] (x)−PAx∥₂²]≦E[∥ [symbol] (x)−Ax|₂²]. (3)

Furthermore, by applying Corollary 7 to [symbol] and PA we are able to prove the corollary 8. The algorithm [symbol] on input x outputs Py where y= [symbol] (x). Since [symbol] is a function of [symbol] (x) only, it satisfies (ε,δ)-differential privacy by Theorem 3. It satisfies (3) since for any y and any projection matrix P it holds that

∥P(y−Ax)∥₂≦∥y−Ax∥₂.

The main technical tool is a linear algebraic fact connecting the determinant lower bound for A and the determinant lower bound for any projection of A.

Lemma 1 states that if we let A be an M×N complex matrix with singular values λ₁≧ . . . ≧λ_{N} and let P be a projection matrix onto the span of the left singular vectors corresponding to λ₁, . . . , λ_{K}, there exists a constant C and K×K submatrix B of PA such that

$${\vert det ( B ) \vert}^{1 / K} \geq C \sqrt{\frac{K}{N}} {( {\prod }_{i = 1}^{K} {λ}_{i} )}^{1 / K}$$

To prove this, we Let C=PA and consider the matrix D=CC^{H} which has eigenvalues λ₁², . . . λ_{K}² and therefore det(D)=πᵢ₌₁^{K}λᵢ². On the other hand, by the Binet-Cauchy formula for the determinant, we have

$$det ( D ) = det ( {CC}^{H} ) = {\sum }_{S ∈ ( \begin{matrix}\vert N \vert \\ K\end{matrix} )} {det ( C {\vert}_{s} )}^{2} \leq {( \begin{matrix}N \\ K\end{matrix} )}_{S ∈ ( \begin{matrix}\vert N \vert \\ K\end{matrix} )} max {det ( C {\vert}_{S} )}^{2}$$

By rearranging and raising to the power ½K, a K×K submatrix of C exists such that

$${\vert det ( B ) \vert}^{1 / K} \geq {( \begin{matrix}N \\ K\end{matrix} )}^{- 1 / 2 K} {( {\prod }_{i = 1}^{K} {λ}_{i} )}^{1 / K}$$

The proof is completed by using the bound

$$( \begin{matrix}N \\ K\end{matrix} ) \leq {( \frac{Ne}{K} )}^{K} .$$

The main lower bound theorem set forth above may be proved by combining Corollary 8 and Lemma 1 to arrive at Theorem 9. Theorem 9 states that hε [symbol] ^{N} may be an arbitrary real vector and the Fourier coefficients of it are relabeled so that |ĥ₀≧ . . . ≧|ĥ_{N-1}|. Thus, for all sufficiently small ε and δ, the expected mean squared error of any (ε,δ)-differentially private algorithm [symbol] that approximates the convolution h*x is at least

$$M S E = Ω ( \begin{matrix}\begin{matrix}N \\ max\end{matrix} \\ K = 1\end{matrix} \frac{{K}^{2} {\hat{h}}_{K - 1}^{2}}{N {log}^{2} N} ) \qquad ( 4 )$$

The proof of Equation 4 is as follows. h*x is expressed as the linear map Hx, where H is the convolution matrix for h. By Corollary 8, it suffices to show that for each K, there exists a projection matrix P and a K×K submatrix B of PH such that |det (B)|^{1/K}≧Ω(\sqrt{K}|ĥ_{K}|). By recalling that the eigenvalues of H are \sqrt{N}ĥ₀, . . . , \sqrt{N}ĥ_{N-1}, it follows that the i-th singular value of H is \sqrt{N}∥ĥᵢ₋₁|. The proof is completed by looking to Lemma 1, which states that there exists a constant C, a projection matrix P, and a submatrix B of PH such that

$${\vert det ( B ) \vert}^{1 / K} \geq C \sqrt{\frac{K}{N}} {( {\prod }_{i = 0}^{K - 1} \sqrt{N} \vert {\hat{h}}_{i} \vert )}^{1 / K} \geq C \sqrt{K} \vert {\hat{h}}_{K} \vert$$

Hereinafter, we define the notation specLB (h) for the right hand side of Equation 4, i.e.

$$specLB ( h ) = {max}_{K = 1}^{N} \frac{{K}^{2} {\hat{h}}_{K - 1}^{2}}{N {log}^{2} N} .$$

We next consider the definition of the upperbounds used in the privacy algorithm according to invention principles.

Generalizations

Standard (ε, δ)-privacy techniques such as input perturbation or output perturbation in the time or in the frequency domain lead to mean squared error, at best, proportional to ∥h∥₂². Next we describe the algorithm according to invention principles which is nearly optimal for (ε, δ)-differential privacy. This algorithm is derived by formulating the error of a natural class of private algorithms as a convex program and finding a closed form solution.

Consider the class of algorithms, which first add independent Laplacian noises zᵢ=Lap(0, bᵢ) to the Fourier coefficients \hat{x}ᵢ to compute \tilde{x}ᵢ=\hat{x}ᵢ+zᵢ, and then output \tilde{y}=F_{N}^{H}Ĥ \tilde{x}. This class of algorithms is parameterized by the vector b=(b₀, . . . , b_{N-1}) and a member of the class will be denoted [symbol] (b) (b) in the sequel. The question address by the present algorithm is: For given ε, δ>0, how should the noise parameters b be chosen such that the algorithm [symbol] (b) (b) achieves (ε, δ)-differential privacy in x for l₁ neighbors, while minimizing the mean squared error MSE? It turns out that by convex programming duality we can derive a closed form expression for the optimal b, and moreover, the optimal [symbol] (b) is nearly optimal among all (ε, δ)-differentially private algorithms. The optimal parameters are used in Algorithm 1.

```
Algorithm 1 INDEPENDENT LAPLACIAN NOISE
$Set γ = \frac{2 ln ( 1 / δ ) {\vert \vert \hat{h} \vert \vert}_{1}}{{ɛ}^{2} N}$
Compute \hat{x} =F_{N}X and ĥ =F_{N}h
for all i ε {0, . . . , N − 1} do
  if |ĥᵢ| > 0 then
    $Set {z}_{i} = Lap ( \sqrt{\frac{γ}{\vert {h}_{i} \vert}} )$
  else if |ĥᵢ| = 0 then
    Set zᵢ = 0
  end if
    Set \tilde{x}ᵢ = \hat{x}ᵢ + zᵢ.
    Set y̅ᵢ = \sqrt{N}ĥᵢ \tilde{x}ᵢ.
end for
  Output \tilde{y} = F^{H}_{N} y̅
```

Algorithm 1 satisfies (ε, δ)-differential privacy, and achieves expected mean squared error.

$$M S E = 4 \frac{ln ( 1 / δ )}{{ɛ}^{2} N} {‖ \hat{h} ‖}_{1}^{2} . \qquad ( 5 )$$

Equation 5 may be proved by denoting the set I={0≦i≦N−1: |ĥᵢ|>0} and formulating the problem of finding the algorithm [symbol] (b) which minimizes MSE subject to privacy constraints as the following optimization problem

$$\begin{matrix}{min}_{{\{ {b}_{i} \}}_{i ∈ I}} {\sum }_{i ∈ I} {b}_{i}^{2} {\vert {\hat{h}}_{i} \vert}^{2} & ( 6 ) \\ s . t . {\sum }_{i ∈ I} \frac{1}{{Nb}_{i}^{2}} = \frac{{ɛ}^{2}}{2 ln ( 1 / δ )} & ( 7 ) \\ {b}_{i} > 0 , {∀}_{i} ∈ I . & ( 8 )\end{matrix}$$

Formulating this as the above optimization problem is justified as follows.

With respect to the privacy constraint, we first show that the output \tilde{y} of an algorithm [symbol] (b) is a (ε, δ)-differentially private function of x, if the constraint in Equation (7) is satisfied. If y̅=Ĥ\tilde{x} is denoted as such, then If y̅ is an (ε, δ)-differentially private function of x, by Theorem 3, \tilde{y} is also (ε, δ)-differentially private, since the computation of \tilde{y} depends only on F_{N}^{H} and y̅ and not on x directly. Thus we can focus on the requirements on b for which y̅ is (ε, δ) private.

If i∉I then y̅ᵢ=0 and does not affect privacy regardless of bᵢ. Thus, we can set bᵢ=0 for all i∉I. If i∈I we first characterize the l₁-sensitivity of \hat{x}ᵢ as a function of x. Recall that \hat{x}ᵢ=fᵢ^{H}x is the inner product of x with the Fourier basis vector fᵢ. The sensitivity of \hat{x}ᵢ is therefore

$${‖ {f}_{i} ‖}_{∞} = \frac{1}{\sqrt{N}} ,$$

∀ᵢ. Then by Theorem 2, \tilde{x}ᵢ=\hat{x}ᵢ+Lap(0, bᵢ) is εᵢ-differentially private in x with

$${ɛ}_{i} = \frac{1}{\sqrt{N} {b}_{i}} .$$

The computation of y̅ᵢ depends only on ĥᵢ and \tilde{x}ᵢ. Thus, by Theorem 3, y̅ᵢ is

$$\frac{1}{\sqrt{N} {b}_{i}} -$$

differentially private in x. Finally, according to Theorem 4, y̅ is (ε, δ) differentially private for any δ>0, as long as the constraint in Equation (7) holds true. Turning now to the accuracy objective, the present algorithm [symbol] (b) which minimizes the MSE is equivalent to finding the parameters bᵢ>0,iεI which minimize the objective function of Equation (6). To ensure this is true we note that \tilde{y}=F_{N}^{H}Ĥ(F_{N}x+z)=y+F_{N}^{H}Ĥ_{z}.
Thus, the output \tilde{y} is unbiased: E[\tilde{y}]=y and the MSE is give as

$$M S E = \frac{1}{N} E [ {‖ \begin{matrix}{F}_{N}^{H} \hat{H} & z\end{matrix} ‖}_{2}^{2} ] = \frac{1}{N} E [ tr ( \begin{matrix}{F}_{N}^{H} \hat{H} & {zz}^{H} \hat{H} {F}_{N}\end{matrix} ) ] = \frac{1}{N} tr ( {\hat{H}}^{2} E [ {zz}^{H} ] ) = 2 {\sum }_{i ∈ I} {\vert {\hat{h}}_{i} \vert}^{2} {b}_{i}^{2}$$

which yields the objective function of Equation (6).

A closed form solution is developed because the program in Equations (6)-(8) is convex in 1/bᵢ². By using convex programming duality, we can derive a closed form optimal solution as bᵢ*={square root over ((2 ln(1/δ)∥ĥ∥₁)/Nε²|ĥᵢ|))} when iεI and bᵢ*=0 otherwise. By substituting these values back into the objective, the proof is finalized.

We are then able to determine a closed form solution of Equations (6)-(8) using convex programming duality. This is accomplished by substituting aᵢ=1/bᵢ² which is shown as

$${min}_{{\{ {a}_{i} \}}_{i ∈ I}} {\sum }_{i ∈ I} \frac{{\vert {\hat{h}}_{i} \vert}^{2}}{{a}_{i}}$$

$$s . t . {\sum }_{i ∈ I} {a}_{i} = \frac{N {ɛ}^{2}}{2 ln ( 1 / δ )}$$

$${a}_{i} > 0 , {∀}_{i} ∈ I .$$

### The Lagrangian is

$$L ( a , v , Λ ) = {\sum }_{i ∈ I} \frac{{\vert {\hat{h}}_{i} \vert}^{2}}{{a}_{i}} + v ( {\sum }_{i ∈ I} {a}_{i} - \frac{N {ɛ}^{2}}{2 ln ( 1 / δ )} ) - {\sum }_{i ∈ I} {λ}_{i} {a}_{i}$$

The KKT conditions are given by

$${∀}_{i} ∈ I , - \frac{{\vert {\hat{h}}_{i} \vert}^{2}}{{a}_{i}} + v - {λ}_{i} = 0$$

$${\sum }_{i ∈ I} {a}_{i} - \frac{N {ɛ}^{2}}{2 ln ( 1 / δ )} = 0$$

$${λ}_{i} {a}_{i} = 0$$

$${a}_{i} \geq 0 , {λ}_{i} \geq 0$$

The following solution (a*,v*,Λ*) satisfied the KKT conditions, and is thus the optimal solution is

$${∀}_{i} ∈ I , {a}_{i}^{+} = \frac{N {ɛ}^{2}}{2 ln ( 1 \text{/} δ ) {‖ \hat{h} ‖}_{1}} \vert {\hat{h}}_{i} \vert , {λ}_{{i}_{i}}^{*} = 0 , {v}^{*} = {( \frac{2 ln ( 1 \text{/} δ ) {‖ \hat{h} ‖}_{1}}{N {ɛ}^{2}} )}^{2}$$

Consequently, the optimal noise parameters b for the original problem (6)-(8), and the associated MSE are

$${b}_{i}^{*} = \{ \begin{matrix}\sqrt{\frac{2 ln ( 1 \text{/} δ ) {‖ \hat{h} ‖}_{1}}{N {ɛ}^{2} \vert {\hat{h}}_{i} \vert} if i ∈ I} \\ 0 if i ∉ I\end{matrix} \\ {MSE}^{*} = 2 {\sum }_{i ∈ I} {\vert {\hat{h}}_{i} \vert}^{2} {b}_{i}^{2} = 4 \frac{ln ( 1 \text{/} δ )}{{ɛ}^{2} N} {‖ \hat{h} ‖}_{1}^{2}$$

which are the noise parameters and MSE of Algorithm 1.

Theorem 11 states that for any h, the present algorithm shown in Algorithm 1 satisfies (ε, δ)-differential privacy and achieves expected mean squared error

$$( specLB ( h ) \frac{{log}^{2} N {log}^{2} \vert I \vert ln ( 1 \text{/} δ )}{{ɛ}^{2}} ) .$$

This may be proved by assuming |ĥ₀|>|ĥ₁| . . . >|ĥ_{N-1}|. Then by defining I={0≦i≦N−1: |ĥᵢ|>0}, we have |ĥⱼ|=0 for all j>|I|−1. Thus,

$${‖ \hat{h} ‖}_{1} = {\sum }_{i = 0}^{\vert I \vert - 1} \vert {\hat{h}}_{i} \vert = {\sum }_{i = 1}^{I} \frac{1}{i} i \vert {\hat{h}}_{i - 1} \vert \leq ( {\sum }_{i = 1}^{I} \frac{1}{i} ) \sqrt{N} log N \sqrt{specLB ( h )} = {H}_{\vert I \vert} \sqrt{N} log N \sqrt{specLB ( h )} \qquad ( 9 )$$

Where

$${H}_{m} = {\sum }_{i = 1}^{m} \frac{1}{i}$$

denotes the m-th harmonic number. Recalling that Hₘ=O(log m), and combining the bound set forth in Equation 9 with the expression of MSE of Theorem 11, yields the desired bound. Thus, Theorem 11 shows that Algorithm 1 is almost optimal for any given h. We also compute explicit asymptotic error bounds for a particular case of interest, compressible h, for which Algorithm 1 outperforms input and output perturbation.

Definition 6. A vector h∈ [symbol] ^{N} is (c, p)-compressible (in the Fourier basis) is it satisfies:

$$∀ 0 \leq i \leq N - 1 \text{:} {\vert {\hat{h}}_{i} \vert}^{2} \leq c \frac{1}{( i + 1 ) p} .$$

Lemma 2. Let h be a (c, p)-compatible vector for some p>1. The, we have

$${‖ \hat{h} ‖}_{i} = {\sum }_{i = 0}^{\vert I \vert - 1} \vert {\hat{h}}_{i} \vert \leq \{ \begin{matrix}c ( 1 + ln \vert I \vert ) , if p = 2 \\ \frac{cp}{p - 2} , if p > 2\end{matrix}$$

Proof. Approximating a sum by an integral in the usual way, for 0≦a≦b and p≦2, we have

$${\sum }_{i = a}^{b} \frac{1}{{( i + 1 )}^{p / 2}} = {\sum }_{i = a + 1}^{b + 1} \frac{1}{{i}^{p / 2}} \leq \frac{1}{{( a + 1 )}^{p / 2}} + {\int }_{a + 1}^{b + 1} \frac{d x}{{x}^{p / 2}} \leq \{ \begin{matrix}1 + ln \frac{b + 1}{a + 1} , if p = 2 \\ 1 + \frac{1}{( p \text{/} 2 - 1 ) {( a + 1 )}^{p / 2 - 1}} , if p > 2\end{matrix} \qquad ( 10 )$$

The lemma then follows from the definition of (c,p)-compressibility. Theorem 12 and Theorem 13 then follow from Theorem 10 and Lemma 2. More specifically, Theorem 12 stats that if we set h as a (c,2)-compressible vector, then Algorithm 1 satisfies (ε, δ)-differential privacy and achieves expected mean squared error

$$( \frac{{c}^{2} {log}^{2} \vert I \vert ln ( 1 \text{/} δ )}{N {ɛ}^{2}} ) .$$

Theorem 13 states that if we set h as a (c,p)-compressible vector for some constant p>2, then Algorithm 1 satisfies (ε, δ)-differential privacy and achieves expected means square error

$$O ( {( \frac{cp}{p - 2} )}^{2} \frac{ln ( 1 \text{/} δ )}{N {ɛ}^{2}} ) .$$

In an alternate embodiment, the privacy algorithm according to invention principles may be considered a spectrum partitioning algorithm. The spectrum of the convolution matrix H may be partitioned into geometrically growing in size groups and different amounts of noise are added to each group. The added noise is added in the Fourier domain, i.e. to the Fourier coefficients of the private input x. The most noise is added to those Fourier coefficients which correspond to small (in absolute value) coefficients of h, making sure that privacy is satisfied while the least amount of noise is added. In the analysis of optimality, we show that the noise added to each group can be charged to the lower bound specLB(h). Because the number of groups is logarithmic in N, we get almost optimality. The present algorithm is simpler and significantly more efficient than those set forth by Hardt and Talwar.

Another (ε, δ)-differentially private algorithm we propose for approximating h*x is shown as Algorithm 2. In the remainder of this section we assume for simplicity that N is a power of 2. We also assume, for ease of notation that, |ĥ₀| . . . ≧|ĥ_{N-1}|. This algorithm and analysis do not depend on i except as an index, so this comes without the loss of generality. Algorithm 2 is as follow:

```
Algorithm 2 SPECTRAL PARTITION
$Set η = \frac{\sqrt{2 ( 1 + log N ) ln ( 1 / δ )}}{ɛ}$
Compute \hat{x} = F_{N}x and ĥ = F_{N}h
\tilde{x}₀ = \hat{x}₀ + Lap(η)
for all k ε [1, logN] do
  for all i ε [N/2^{k}, N/2^{k-1} − 1] do
    Set \tilde{x}ᵢ = \hat{x}ᵢ + Lap (η2^{-K/2}).
    Set y̅ᵢ = \sqrt{N}ĥᵢ\hat{x}ᵢ.
  end for
end for
Output \tilde{y} = F^{H}_{N} y̅
```

From Algorithm 2 discussed above, we get Lemma 3 which states that Algorithm 2 satisfies (ε, δ)-differential privacy and that there exists an absolute constant C such that Algorithm 2 achieves expected mean squared error

$$MSE \leq C \frac{( 1 + log N ) log ( 1 / δ )}{{ɛ}^{2}} ( {\vert {\hat{h}}_{0} \vert}^{2} + {\sum }_{k = 1}^{log N} \frac{1}{{2}^{k}} {\sum }_{i = N / {2}^{k}}^{N / {2}^{k - 1}} {\vert {\hat{h}}_{i} \vert}^{2} ) \qquad ( 11 )$$

The proof that Algorithm 2 also satisfies the desired level of privacy is shown in terms of privacy and accuracy. With respect to privacy, \tilde{x} is an (ε, δ)-differentially private function of x. The other computations depend only on h and \tilde{x} and not on x directly. Thus, by Theorem 3, it incurs no loss of privacy. By analyzing the sensitivity of each Fourier coefficient \tilde{x}ᵢ. As a function of x, \tilde{x}ᵢ is an inner product of x with a Fourier basis vector. Let that vector be f and let x, x′ be two neighboring inputs, i.e. ∥x−x′∥₁≦1. This produces

$$\vert {f}^{H} ( x - {x}^{′} ) \vert \leq {‖ f ‖}_{∞} {‖ x - {x}^{′} ‖}_{1} \leq \frac{1}{\sqrt{N}} .$$

Therefore, by Theorem 2, when i∈[N/2^{k}, N/2^{k}−1], \tilde{x}ᵢ is

$$( \frac{{2}^{k / 2}}{\sqrt{N} η} , 0 )$$

differentially private and by Theorem 4, \tilde{x} is (ε′, δ) differentially private for any δ>0, where

$${ɛ}^{′2} = 2 ln ( 1 \text{/} δ ) ( \frac{1}{{η}^{2}} + {\sum }_{k = 1}^{logN} \frac{N}{{2}^{k}} \frac{{2}^{k}}{N {η}^{2}} ) = 2 ln ( 1 \text{/} δ ) \frac{1 + log N}{{η}^{2}} = {ɛ}^{2}$$

Turning now to accuracy, E[\tilde{x}ᵢ]=\hat{x}ᵢ because an unbiased amount of Laplace Noise to each \hat{x}ᵢ. Additionally, the variance of Lap(η2^{-k/2}) is 2η²2^{-k}. Therefore, E[ y̅ᵢ]=\sqrt{N}ĥᵢ\hat{x}ᵢ and the variance of y̅ᵢ when i∈[N/2^{k}, N/2^{k-1}−1] is O (N|ĥᵢ|²η²2^{-k}). By linearity of expectation, E[F_{N}^{H} y̅]=Hx and by adding variances for each of k and dividing N, we get the right hand side of Equation (11). The proof is completed by observing that the inverse Fourier Transform F_{N}^{H} is an isometry for the l₂ norm and therefore does not change the mean squared error.

From there, the following is true. For any h, Algorithm 2 satisfies (ε, δ)-differential privacy and achieves the expected mean squared error

$$O ( specLB ( h ) ) \frac{{log}^{4} N ln ( 1 \text{/} δ )}{{ɛ}^{2}} .$$

As proof of this, based on Lemma 3,

$$MSE \leq C \frac{( log N ) log ( 1 \text{/} δ )}{{ɛ}^{2}} ( {\vert {\hat{h}}_{0} \vert}^{2} + {\sum }_{k = 1}^{log N} \frac{N}{{2}^{2 k}} {\vert {\hat{h}}_{N / {2}^{k - 1} - 1} \vert}^{2} ) = O ( specLB ( h ) ) \frac{{log}^{4} N ln ( 1 \text{/} δ )}{{ɛ}^{2}} .$$

We are then able to determine a closed form solution of Equations (6)-(8) using convex programming duality.

The above described privacy algorithm has many applications. Some of the generalizations and applications of our lower bounds and algorithms for private convolution are discussed below. It should be understood that the following is described for purposes of example only and persons skilled in the art will readily understand that the algorithm described above may be extended to other objectives and goals.

In one example, Algorithm 1 enables private circular convolutions to problems in finance. This example relates to Linear Filters in Time Series Analysis. Linear filtering is a fundamental tool in analysis of time-series data. A time series is modeled as a sequence x=(xₜ)_{t=-∞}^{∞}, supported on a finite set of time steps. A filter converts the time series into another time series. A linear filter does so by computing the convolution of x with a series of filter coefficients w, i.e. computing yₜ=Σ_{i=-∞}^{∞} wᵢ xₜ₋ᵢ. For a finitely supported x, y can be computed using circular convolution by restricting x to its support set and padding with zeros on both sides.

In this example, x is a time series of sensitive events. In particular, this is relevant to financial analysis, but the methods are applicable to other instances of time series data. The time series can be the aggregation of various client data, e.g. counts or values of individual transactions (where the value of an individual transaction is much smaller than total value), employment figures, etc. Beyond financial analysis, we may also consider network traffic logs or a time series of movie ratings on an online movie streaming service.

We can perform almost optimal differentially private linear filtering by casting the filter as a circular convolution. Next we briefly describe a couple of applications of private linear filtering to financial analysis.

Volatility Estimation.

The value at risk measure is used to estimate the potential change in the value of a good or financial instrument, given a certain probability threshold. In order to estimate value at risk, we need to estimate the standard deviation of the value for a given time period. It is appropriate to take older fluctuations with less significance. The standard way to do so is by linear filtering, where the filter has exponentially decaying weights λⁱ for appropriately chosen λ<1.

Business Cycle Analysis.

The goal of business cycle analysis is to extract cyclic components in the time series and smooth-out spurious fluctuation. Two classical methods for business-cycle analysis are the Hodrick-Prescott filter and the Baxter-King filter. Both methods employ linear filtering to extract the business cycle component of the time series. These methods are appropriate for macroeconomic data, for example unemployment rates.

In another example, the algorithm may be used in convolutions over Abelian Groups. Circular convolution is a special case of the more general concept of convolution over finite Abelian groups. Let G be an Abelian group and let x: G→ [symbol] and h: G→ [symbol] be functions mapping G to the complex numbers. We define the convolution x*h: G→ [symbol] of x and h has:

$$( x * h ) ( a ) = {\sum }_{a ∈ G} x ( b ) h ( a - b )$$

In the above equation the operation a-b is over the group G. Circular convolution is the special case G= [symbol] /N [symbol] (i.e. when G is the additive group of integers modulo N). Similarly, we can think of x and h above as sequences of length |G| indexed by elements of G, where xₐ is an alternative notation for x(a). This more general form of convolution shares most important properties of circular convolution: it is commutative and linear in both x and h; also x*h can be diagonalized by an appropriately defined Fourier basis which reduces to F_{N} as defined above in the case of [symbol] G/N [symbol] . In particular, x*h (as say a linear operator on x) is diagonalized by the irreducible characters of G. Irreducible characters of G and the corresponding Fourier coefficients of a function x can be indexed by the elements of G (as a special case of Pontryagin duality).

The results of our algorithm carry over to the general case of convolution over Abelian groups, because we do not rely in any way on the structure of [symbol] G/N [symbol] . In any theorem statement and algorithm description, the private sequence x and the public sequence h h can be thought of as functions with domain a group G; the parameter N can be substituted by |G| and Fourier coefficients can be indexed by elements of G instead of the numbers 0, . . . , N−1. The properties of the Fourier transform that we use are: (1) it diagonalizes the convolution operator; (2) any component of any Fourier basis vector has norm 1/\sqrt{N}=1/\sqrt{|G|}. Both these properties hold in the general case.

A further example may be found in terms of generalized marginal queries. In the case G=( [symbol] /2 [symbol] )^{d} each element a of G can be represented as a 0-1 sequence a₁, . . . , a_{d}, and also as a set S⊂[d] for which a is an indicator. Characters χₛ:G→ [symbol] are indexed by sets S⊂g [d] and are defined by

$${χ}_{S} ( a ) = \frac{1}{{2}^{d / 2}} {\prod }_{i ∈ S} {( - 1 )}^{{a}_{i}} .$$

Fourier coefficients of a function g: G→ [symbol] are also indexed by sets S⊂g [d]; the coefficient of g corresponding to χₛ is denoted ĝ(S). Some aggregation operations on databases with d binary attributes can be naturally expressed as convolutions over ( [symbol] /2 [symbol] )^{d}. Consider a private database D, modeled as a multiset of n binary strings in {0,1}^{d}, i.e. Dε({0,1}^{d})ⁿ. Each element of D corresponds to a user whose data consists of the values of d binary attributes: the i-th bit in the binary string of a user is the value of the i-th attribute for that user. The database D can be represented as a sequence x of length 2^{d} or equivalently as a function x: {0,1}^{d}→[n], where for aε{0,1}^{d}, x(a) is the number of users whose attributes are specified by a (i.e. the number of occurrences of a in D). Note that x can be thought of as a function from ( [symbol] /2 [symbol] )^{d}→[n]. Note also that removing or adding a single element to D changes x (thought of as a vector) by at most 1 in the l₁ norm.
Consider a convolution x*h of the database x with a binary function h: ( [symbol] /2 [symbol] )^{d}→{0,1}. Let 1{aᵢ≠bᵢ} be an indicator of the relation aᵢ≠bᵢ. Then x*h represents the following aggregation

$$( x * h ) ( a ) = {\sum }_{b ∈ {\{ 0 , 1 \}}^{d}} x ( b ) h ( 1 \{ {a}_{1} \neq {b}_{1} \} , … , 1 \{ {a}_{d} \neq {b}_{d} \} ) .$$

A class of functions h that has received much attention in the differential privacy literature is the class of conjunctions. In that case, h is specified by a set S⊂g [d] of size w and h(c)=1 if and only if cᵢ=0 for all i∈S. Thus, h(c)= [symbol] _{i∈s} c̅ₗ. For any such h, the convolution x*h evaluated at a gives a w-way marginal: for how many users do the attributes corresponding to the set S equal the corresponding values in a. The full sequence x*h gives all marginals for the set S of attributes. Here we define a generalization of marginals that allows h to be not only a conjunction of w literals, but an arbitrary w-DNF.

If we let h(c) be a w-DNF given by h(c)=(l_{1,1} [symbol] . . . [symbol] l_{1,w}) [symbol] . . . [symbol] (l_{s,1} [symbol] . . . [symbol] l_{s,w}), where l_{i,j} is a literal, i.e. either cₚ or c̅ₚ for some p∈[d], then the generalized marginal function for h and a database x: {0,1}^{d}→[n] is a function (x*h): {0,1}^{d}→[n] defined by

$$( x * h ) ( a ) = {\sum }_{b ∈ {\{ 0 , 1 \}}^{d}} x ( b ) h ( 1 \{ {a}_{1} \neq {b}_{1} \} , … , 1 \{ {a}_{d} \neq {b}_{d} \} ) .$$

The overload of notation for x*h here is on purpose as the generalized marginal is indeed the convolution of x and h over the group ( [symbol] /2 [symbol] )^{d}. While marginals give, for each setting of attributes a, the number of users whose attributes agree with a on some S, generalized marginals allow more complex queries such as, for example, “show all users who agree with a on a₁ and at least one other attribute.” Generalized marginal queries can be computed by a two-layer AC0 circuit. However, our results are incomparable to theirs, as they consider the setting where the database is of bounded size ∥x∥₁≦n and our error bounds are independent of ∥x∥₁.

We use a concentration result for the spectrum of w-DNF formulas, originally proved by Mansour in the context of learning under the uniform distribution. If we let h: {0,1}^{d}→{0,1} be a w-DNF. Let [symbol] ⊂2^{[d]} be the index set of the top 2^{d-k} Fourier coefficients of h, then

$${\sum }_{S ∉ ℱ} {\vert \hat{h} ( S ) \vert}^{2} \leq {2}^{d + \frac{k - d}{O ( w log w )}} .$$

Plugging this into Lemma 3 we get the following result for computing private generalized marginals of Theorem 15. Theorem 15 states that if h is a w-DNF and x: {0,1}^{d}→[n] is a private database. Algorithm 1 satisfies (ε, δ)-differential privacy and computes the generalized marginal x*h for h and and x with mean squared error bounded by

$$O ( \frac{ln ( 1 / δ )}{{ɛ}^{2}} {2}^{d ( 1 - 1 / O ( w log w ) )} ) .$$

In addition to this explicit bound, we also know that up to a factor of d⁴. Algorithm 1 is optimal for computing generalized marginal functions. Notice that error bound we proved improves on randomized response by a factor of 2^{-Ω(d/(w log w))}. Interestingly this factor is independent of the size of the w-DNF formula.

In conclusion, the nearly tight upper and lower bounds on the error of (ε, δ)-differentially private for computing convolutions are derived. The lower bounds rely on recent general lower bounds based on discrepancy theory and the upper bound is a computationally efficient algorithm.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms (for example, a hardware apparatus, hardware and software apparatus, or a computer-readable media). An apparatus may be implemented in, for example, appropriate hardware, software, and firmware. The methods may be implemented in, for example, an apparatus such as, for example, a processor, which refers to any processing device, including, for example, a computer, a microprocessor, an integrated circuit, or a programmable logic device. Processing devices also include communication devices, such as, for example, computers, cell phones, tablets, portable/personal digital assistants (“PDAs”), and other devices that facilitate communication of information between end-users.

Additionally, the methods may be implemented by instructions being performed by a processor, and such instructions may be stored on a processor or computer-readable media such as, for example, an integrated circuit, a software carrier or other storage device such as, for example, a hard disk, a compact diskette, a random access memory (“RAM”), a read-only memory (“ROM”) or any other magnetic, optical, or solid state media. The instructions may form an application program tangibly embodied on a computer-readable medium such as any of the media listed above. As should be clear, a processor may include, as part of the processor unit, a computer-readable media having, for example, instructions for carrying out a process. The instructions, corresponding to the method of the present invention, when executed, can transform a general purpose computer into a specific machine that performs the methods of the present invention.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A method for computing a private convolution comprising:
receiving private data, x, the private data x being stored in a database;
receiving public data, h, the public data h being received from a querier;
transforming, by a controller, the private and public data to obtain transformed private data \hat{x} and transformed public data Ĥ;
adding, by a privacy processor, noise to the transformed private data \hat{x} to obtain a noisy transformed private data \tilde{x};
multiplying, by the privacy processor, the noisy transformed private data with the transformed public data to obtain a product data y̅=Ĥ\tilde{x}; and
inverse transforming, by the privacy processor, the product data to obtain privacy preserving output \tilde{y}
releasing \tilde{y} to the querier.

2. The method of claim 1, wherein the transform is one of a Fourier transform and a transform by additive Laplacian noise.

3. The method of claim 1, wherein the noise is zero mean.

4. The method of claim 3, wherein the noise is one of a Laplacian noise and Gaussian noise.

5. The method of claim 3, wherein the noise is Laplacian and satisfies one of equation:
(a) z₀=Lap(η) and zᵢ=Lap (η2^{-k/2}) for i in [N/2^{k}, N/2^{k-1}−1], where
$$η = \frac{\sqrt{2 ( 1 + log N ) ln ( 1 / δ )}}{ɛ} ;$$
or
(b) for i in[0,N−1],
$${z}_{i} = Lap ( \sqrt{\frac{γ}{{\hat{h}}_{i}}} ) if \vert {\hat{h}}_{i} \vert > 0 ,$$
or zᵢ=0 if |ĥᵢ|=0, where
$$γ = \frac{2 ln ( \frac{1}{δ} ) {‖ \hat{h} ‖}_{1}}{{ɛ}^{2} N}$$

6. The method of claim 1 for use in linear filtering.

7. The method of claim 6 for use in time series analysis, or financial analysis, including one of volatility estimation and business cycle analysis.

8. The method of claim 1 for use in generalized marginal queries.

9. An apparatus for computing a private convolution comprising:
a database having private data, x, stored therein
a controller that receives public data, h, from a querier and transforms the
private and public data to obtain transformed private data \hat{x}
and transformed public data Ĥ; and
a privacy processor that
adds noise to the transformed private data \hat{x} to obtain a noisy transformed private data \tilde{x};
multiplies the noisy transformed private data with the transformed public data to obtain a product data y̅=Ĥ\tilde{x}; and
inverse transforms the product data to obtain privacy preserving output \tilde{y} for release to the querier.

10. The apparatus of claim 9, wherein
the transform is one of a Fourier transform and a transform by additive Laplacian noise.

11. The apparatus of claim 9, wherein
the noise is zero mean.

12. The apparatus of claim 11, wherein the noise is one of a Laplacian noise and Gaussian noise.

13. The apparatus of claim 11, wherein
the noise is Laplacian and satisfies one of equation:
(a) z₀=Lap(η) and zᵢ=Lap (η2^{-k/2}) for i in [N/2^{k}, N/2^{k-1}−1], where
$$η = \frac{\sqrt{2 ( 1 + log N ) ln ( 1 / δ )}}{ɛ} ;$$
or
(b) for i in[0,N−1]
$${z}_{i} = Lap ( \sqrt{\frac{γ}{{\hat{h}}_{i}}} ) if \vert {\hat{h}}_{i} \vert > 0 ,$$
or zᵢ=0 if |ĥᵢ|=0, where
$$γ = \frac{2 ln ( \frac{1}{δ} ) {‖ \hat{h} ‖}_{1}}{{ɛ}^{2} N}$$

14. The apparatus of claim 9, wherein
the apparatus performs linear filtering of data.

15. The apparatus of claim 14, wherein
the linear filtering is performed during financial analysis, the financial analysis including one of volatility estimation and business cycle analysis.

16. The apparatus of claim 9, wherein
the apparatus executes generalized marginal queries.

17. An apparatus for computing a private convolution comprising:
means for storing private data, x
means for receiving public data, h, from a querier;
means for transforming the private and public data to obtain transformed private data \hat{x} and transformed public data Ĥ;
means for adding noise to the transformed private data \hat{x} to obtain a noisy transformed private data \tilde{x};
means for multiplying the noisy transformed private data with the transformed public data to obtain a product data y̅=Ĥ\tilde{x}; and
means for inverse transforms the product data to obtain privacy preserving output \tilde{y} for release to the querier.

18. The apparatus of claim 17, wherein
the transform is one of a Fourier transform and a transform by additive Laplacian noise.

19. The apparatus of claim 17, wherein
the noise is zero mean.

20. The apparatus of claim 19, wherein the noise is one of a Laplacian noise and Gaussian noise.

21. The apparatus of claim 19, wherein
the noise is Laplacian and satisfies the equation:
the noise is Laplacian and satisfies one of equation:
(a) z₀=Lap(η) and zᵢ=Lap (η2^{-k/2}) for i in [N/2^{k}, N/2^{k-1}−1], where
$$η = \frac{\sqrt{2 ( 1 + log N ) ln ( 1 / δ )}}{ɛ} ;$$
or
(b) for i in[0,N−1],
$${z}_{i} = Lap ( \sqrt{\frac{γ}{{\hat{h}}_{i}}} ) if \vert {\hat{h}}_{i} \vert > 0 ,$$
or zᵢ=0 if |ĥᵢ|=0 where
$$γ = \frac{2 ln ( \frac{1}{δ} ) {‖ \hat{h} ‖}_{1}}{{ɛ}^{2} N}$$

22. The apparatus of claim 17, wherein
the apparatus performs linear filtering of data.

23. The apparatus of claim 14, wherein
the linear filtering is performed during financial analysis, the financial analysis including one of volatility estimation and business cycle analysis.

24. The apparatus of claim 17, wherein
the apparatus executes generalized marginal queries.
